(19) United States
(12) Patent Application Publication
(10) Pub. No.: US 2007/0174246 A1
(43) Pub. Date: Jul. 26, 2007

(54) Multiple client search method and system

(76) Inventors: Johann Tomas Sigurdsson, Montreal (CA); Stephen Lawrence, Palo Alto, CA (US); Xiyuan Xia, Sunnyvale, CA (US); Sergey Yudin, Fremont, CA (US)

Correspondence Address: FISH & RICHARDSON P.C., PO BOX 1022, MINNEAPOLIS, MN, 55440-1022, US

(21) Appl. No.: 11/339,301

(22) Filed: Jan. 25, 2006

(51) Int. Cl. G06F 17/30

(52) U.S. Cl. 707/3

(57) ABSTRACT

A method includes receiving an event indicating an action associated with a first file has been performed by a user using a first client. The action is unrelated to transmitting the first file to another client. The method also includes automatically extracting content from the first file in response to the event using the first client and generating metadata to associate with the content, and transmitting, using the first client, the content and the metadata to a peer client if the peer client and the first client are currently operating and visible to each other on a network. The timing of the transmission is determined automatically after the event is received.

### TECHNICAL FIELD

This document relates to a sharing and search method and system.

### BACKGROUND

As the amount of information that is digitally stored increases, it becomes more difficult and complex for users to locate their digital information when they want it. Additionally, users want to have access to their digital information whether they are on their home computer, using a laptop at work, or on the road with a wireless personal digital assistant.

Some current systems permit a user to move files to a synchronization folder, which can be used to transfer files between two or more clients. These systems, however, may require explicit user action for this synchronization to take place. In this case, even if a user has recently accessed a file, it will not be synchronized unless the user moves it to the synchronization folder. Additionally, when the file is synchronized with an external client, the file may be difficult to locate on the external client. In some cases, the file may be located with several other files in a synchronization folder on the external client. Navigating on the external client to the transferred file may be difficult for a user even if the user can remember where the synchronization folder is located.

### SUMMARY

This document discloses methods and systems that assist users of computing devices in entering to share and find data across those devices.

In one aspect, a method is described. The method includes receiving an event indicating an action associated with a first file has been performed by a user using a first client. The action is unrelated to transmitting the first file to another client. The method also includes automatically extracting content from the first file in response to the event using the first client and generating metadata to associate with the content, and transmitting, using the first client, the content and the metadata to a peer client if the peer client and the first client are currently operating and visible to each other on a network. The timing of the transmission is determined automatically after the event is received.

In one example, the action that is unrelated to transmitting a file can be a file access or a file save, and the extracted content from the first file can be a copy of the file or a copy of the contents of the file. The method can also include, receiving from a server an indication that the server is configured to transmit the content to a requesting client; and having received the indication and if the peer client is not currently networked to the first client, transmitting the content and the metadata to the server. In some implementations, the method further includes receiving requirements from a server, locating the metadata that meets the requirements, and selecting the content associated with the metadata for transmission to the peer client. The requirements can include time stamp values or data bit values. Additionally, the method can include extracting additional content from a plurality of files using the first client in response to a plurality of events occurring on the first client and transmitting the additional content to the peer client based on one or more priority algorithms that specify an order in which the additional content is to be transmitted.

In another example, transmitting the content and metadata to a peer client can include transmitting the content and the metadata to a server, the first client receiving an indication from the server that the server is configured to transmit the content and the metadata to the peer client. Transmitting the content and metadata to a peer client can include transmitting the content and the metadata to a second client. The first client receiving an indication from the second client that the second client is configured to transmit the content and the metadata to the peer client. The method can further include indexing the content before it is transmitted to the peer client so that one or more symbols included in the content are formatted as keys operable to identify the content, and extracting content from a second file independent of an event occurrence, indexing the content from the second file, and transmitting the indexed content to the peer client.

In yet another example, extracting the content from the first file can includes converting the content of the first file into hypertext markup language (HTML) or text. Additionally, extracting the content of the first file may include generating a copy of the first file that retains the first file's original file formatting. The method may also include increasing a throughput threshold for limiting an amount of content passed between the first client and the peer client if an indication is received at the first client that a network connection between the first client and the peer client has a bandwidth that exceeds a predetermined bandwidth value. In some implementations, the method includes associating an expiration date with the content before it is transmitted to the peer client. In other implementations, the method includes transmitting a request to delete the content from the peer client if the content is deleted from the first client.

In a second aspect, a computer system having one or more servers is described. The system includes a table manager module to receive an indication from a first client that a user has performed an action on a file that is unrelated to a transfer of the file. The indication including content extracted from the file and a metadata value assigned to the content. The system also includes a data table to store the content extracted from the file on the first client and the metadata value, an interface to receive from a second client a request for content that is associated with one or more metadata values within a specified metadata value range, and a selection module to initiate transmission of the content to the second client if the metadata value associated with the content is within the specified metadata value range.

In one example, the metadata value can include a time stamp that indicates when the action performed on the file occurred, and the metadata value range includes a sequential range of time stamp values that indicate a period of time. The system can also include an active client list that includes identifiers for clients from which requests for content have been received by the interface within a predetermined period of time. The active client list being used by the table manager module to determine if the content has been transmitted to all listed active clients before the table manager module issues a delete command to remove the content from the data table. The system can include a space quota that includes a limit on an amount of storage space for received content, the space quota being used to trigger a deletion of at least a portion of the content from the data table when the quota is exceeded.

In another example, the system can include a list of source identifiers, one of which specifies the first client from which the content was received, the list of source identifiers being used to initiate a request for the content from the first client if the content has been deleted from the data table before the content is transmitted to the second client. The system can include an authentication manager to transmit client identifiers for the first and second clients and a user identifier associated with the first and second clients to an external server for use in reconstructing the content if the content stored in the data table becomes inaccessible.

In some implementations, the system can include a throughput threshold that includes a limit on an amount of data that is received by the interface within a predetermined time period. The throughput threshold being used by the interface to refuse the receipt of additional content if the amount of data received exceeds the threshold.

In another aspect, a system for sharing data across multiple clients is described. The system includes an event listener at a first client to receive a user-initiated action associated with a file. The action is unrelated to transmitting the file to a second client. The system also includes an extractor at the first client to extract content from the file in response to the event and to generate metadata that is associated with the context, and means for transmitting the content and the metadata from a first client to a second client.

The systems and techniques described here may provide one or more of the following advantages. A system may increase the convenience of exchanging accessed files between multiple computers. Also, a system may increase a user's ability to locate exchanged content. A system can provide a mechanism that enables optimistic deletion of data transmitted by clients. Such a system may reduce the need for storing back-up copies of the data on servers. A system can increase the relevance of the data exchanged between clients by prioritizing the transmission of certain types of data.

The details of one or more embodiments are set forth in the accompanying drawings and the description below. Other features, aspects, and advantages of the described embodiments will be apparent from the description and drawings, and from the claims.

### DESCRIPTION OF DRAWINGS

FIG. 1 is a schematic diagram showing a system for sharing and synchronizing content across multiple client devices.

FIG. 2 is a sequence diagram showing an illustrative method for sharing and synchronizing content across multiple client devices according to the implementation shown in FIG. 1.

FIG. 3 is a block diagram showing the system in FIG. 1 in more detail.

FIG. 4 is a schematic showing a system for sharing and synchronizing content using a mixed peer-to-peer and client/server architecture.

FIG. 5 is a sequence diagram showing an illustrative method for sharing and synchronizing content using the mixed peer-to-peer and server architecture of FIG. 4.

FIG. 6 is another sequence diagram showing an illustrative method for sharing and synchronizing content using a mixed peer-to-peer and server architecture of FIG. 4 when a client that is offline comes online.

FIG. 7 is a block diagram showing particular components of the system shown in FIG. 4 in more detail.

FIG. 8 is a flow chart showing an illustrative method for sharing and synchronizing content across multiple client devices according to the implementation shown in FIG. 4.

FIG. 9 is a schematic showing a general computer system.

Like reference symbols in the various drawings indicate like elements.

### DETAILED DESCRIPTION

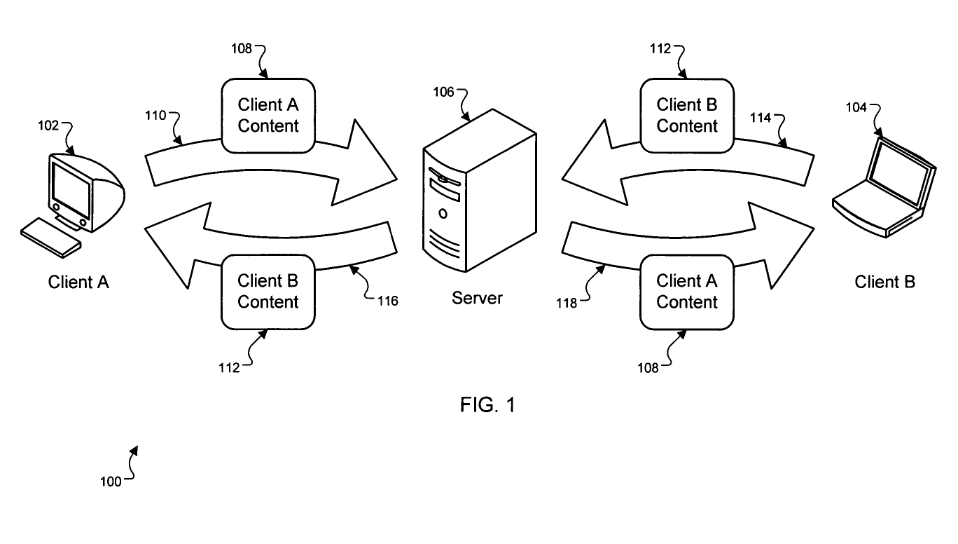

FIG. 1 is a schematic diagram showing a system 100 for sharing and synchronizing content across multiple client devices. The system 100 can permit a user using a second computer device to access copies of files (or copies of the content of the files) that were resident on a first computer device. Exchange of content between the computer devices can occur automatically without a user specifying that the content should be sent to another computer device. For example, a user may edit a word document file at his home computer. When the user saves the document, the document's content is automatically extracted and transmitted to the user's computer at work. When the user searches for the modified document later at his work computer, the content is presented to the user even though the word document was not previously stored on the user's work computer. This can have the additional advantage that only documents that are recently accessed by the user are transferred between the user's various computers.

The system 100 includes a Client A 102, a Client B 104, and a Server 106. The Client A 102 and the Client B 104 represent computers which a user may employ to manage digital information, for example by saving or opening files, or accessing web pages. A user may access many computers including, for example, computers at home, computers at work, and mobile computers, such as personal digital assistants (PDAs) and cell phones. The Server 106 can provide a temporary storage location, or “drop box”, for a user's files, documents, web pages, or the contents of these documents. The drop-box can facilitate sharing this information between the user's computers by storing the shared content if the target computer is offline. Later, when the target computer comes online, the Server 106 may transmit the content to the target computer.

In one implementation, when a user at the Client A 102 performs a file save or an open operation, Client A Content 108 is extracted from the file and is sent to the Server 106, as indicated by arrow 110. For example, the user may save a text file on his home computer. The Client A Content 108, which can include a copy of the user's file, is sent automatically to the Server 106. Similarly, when the user employs the Client B 104 to save or open a file stored on the Client B 104, Client B Content 112 is extracted from the file stored on the Client B 104 and is sent to the Server 106, as indicated by arrow 114. For example, the Client B 104 may be the user's work computer. Because content from the Client A 102 (e.g., the user's home computer) has been transferred to the user's work computer, the user has access to files not previously resident on his work computer. Similarly, the user's home computer now has files previously resident only on the user's work computer. In the implementation shown in FIG. 1, the Server 106 serves as a conduit for sharing file content across the user's work and home computers.

In another example, the Clients A 102 and B 104 may exchange web viewing history. The user may view a website using a web browser installed on the Client B 104 (e.g., the user's work computer). When the web page is accessed, the access may trigger an extraction of the content of the web page, such as a copy of the HTML code. The extracted information can then be transmitted from the Client B 104 to the Server 106. The Client B Content 112 can remain at the Server 106 until the Client A 102 contacts the Server 106 for updates. After the Client A 102 connects to the Server 106, the Server 106 may transmit the content of the web page to the Client A 102 (e.g., the user's home computer).

Later, the user may use a search application, such as the Google™ Desktop search application, to locate the content of the web page. For example, the user may enter text he remembered from the website he viewed at work, such as “Google Expands Its Desktop Role!” The search tool can use this text to locate the web page content that was transmitted from the user's work machine.

The Server 106 can facilitate synchronization of content among the user's computers. When the Client A 102 (e.g., the user's home computer) connects to the Server 106, Client B Content 112 originating from the Client B 104 is automatically copied to the Client A 102, as indicated by arrow 116. In some implementations, copying occurs for the Client B Content 112 not already stored on the Client A 102. Similarly, whenever the Client B 104 (e.g., the user's work computer) connects to the Server 106, any missing Client A Content 108 is copied automatically to the Client B 104, as indicated by arrow 118.

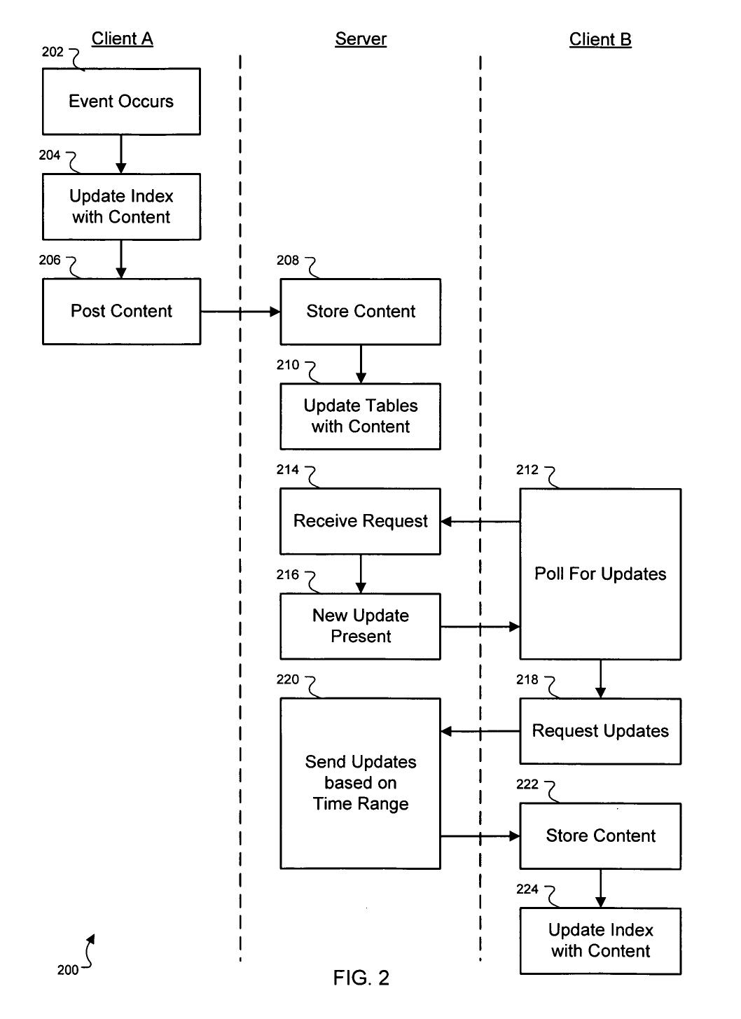

FIG. 2 is a sequence diagram showing an illustrative method 200 for sharing and synchronizing content across multiple client devices according to the implementation shown in FIG. 1. Processing can start in step 202 when an event occurs. The event may signal that an action has occurred, such as the user saving a file or document, accessing a web page, or opening a file. For example, referring to FIG. 1, a user at the Client A 102 may edit and save his resume on his home computer. This action may generate an event that is detected by an event listener.

In step 204, an index is updated with content. For example, after the event triggered by an action is detected, the content from the file associated with the action can be extracted. The extracted content can be the text or images included in the file that was saved, accessed or modified. In some implementations, the extraction can include format conversion. For example, an extractor may convert the text of a file in PDF format to plain text or text in an HTML (hypertext markup language) format. The extracted content can then be used to update the index that links, or associates, the content with metadata or key words from the content. In some implementations, the metadata is a time stamp that specifies when the action is detected. For example, the time stamp can reflect the time that a file was saved, and the extractor may link this time to the content that was extracted when the file was saved. In some implementations, the index is generated using an indexer included in the Google™ Desktop search application. This search application may use the index to locate content on a user's computer.

In step 206, the content extracted by the client is posted to the server. The content is information to be shared on the user's other computers. For example, the extracted content can be the Client A Content 108 that the Client A transmits to the Server 106. The Client A Content 108 may be a text version of the resume the user saved on his home computer. The resume text is sent to the Server 106. Additionally, metadata describing the content, such as the time the resume was saved, can also be transmitted to the Server 106. In step 208, the content received from the originating client is stored on the server.

In step 210, tables maintained at the server are updated to indicate receipt of the content. For example, in FIG. 1, the Server 106 updates database tables with the Client A Content 108 and any corresponding metadata describing the Content 108 it received from the Client A 102. Step 210 can complete the process for facilitating temporary storage of content to be shared with other clients.

Step 202 through step 210 can be performed to provide temporary storage of content originating from any client. For example, referring to FIG. 1, step 202 through step 210 can be performed with respect to the Client B Content 112 on the Client B 104 and the transmission of this content to the Server 106.

In step 212, the second client polls for updates, representing content generated at other clients. For example, referring to FIG. 1, the Client B 104 can poll the Server 106 for new content. Here, the new content can be the Client A Content 108 (e.g., the resume text) stored on the Server 106 but not yet received by the Client B 104.

In step 214, the polling request is received by the server. For example, in FIG. 1, the Server 106 can receive polling requests from the Client B 104.

In step 216, the server indicates to the polling client that content updates are available. For example, in FIG. 1, the Server 106 informs the Client B 104 that the resume text has not been downloaded by the Client B 104 yet. The Server 106 bases this knowledge on time stamps stored in tables. The time stamps correspond to content (e.g., resume text) received earlier by the Server 106 from the Client A 102. The Server 106 compares the time stamps, which can specify when the content was transmitted to the Server 106, to the time range corresponding to the period of time that the Client B 104 has not received new content from the Server 106. In other words, the Server can determine if new content has been generated by another client since the Client B last checked. If the Server 106 finds time stamps in its table within the specified time range, then the Server B 106 can inform the Client B 104 that it has new content.

In step 218, the client requests the updated content that it needs. For example, in FIG. 1, the Client B 104 sends a request to the Server 106 for the missing Client A Content 108. The request may be based on a time range as discussed above.

In step 220, the server sends the updated content corresponding to the time range requested by the server. For example, in FIG. 1, the Server 206 sends the Client A Content 108 to the Client B 104, where the content from the Client A was generated during the time range specified by the client B.

In step 222, the client stores the content locally. For example, in FIG. 1, the Client B 104 stores the Client A Content 108 on a local storage device, such as a hard drive in a personal computer.

In step 224, the client updates its index to reflect the content it received from the other client via the server. For example, in FIG. 1, the Client B 104 updates an index, such as the index used by Google™ Desktop, to reflect the Client A Content 108 it received.

Step 212 through step 224 can represent synchronization steps used by any of the user's clients. For example, referring to FIG. 1, step 212 through step 224 can represent synchronization steps used to update the Client A 102 with the Client B Content 112.

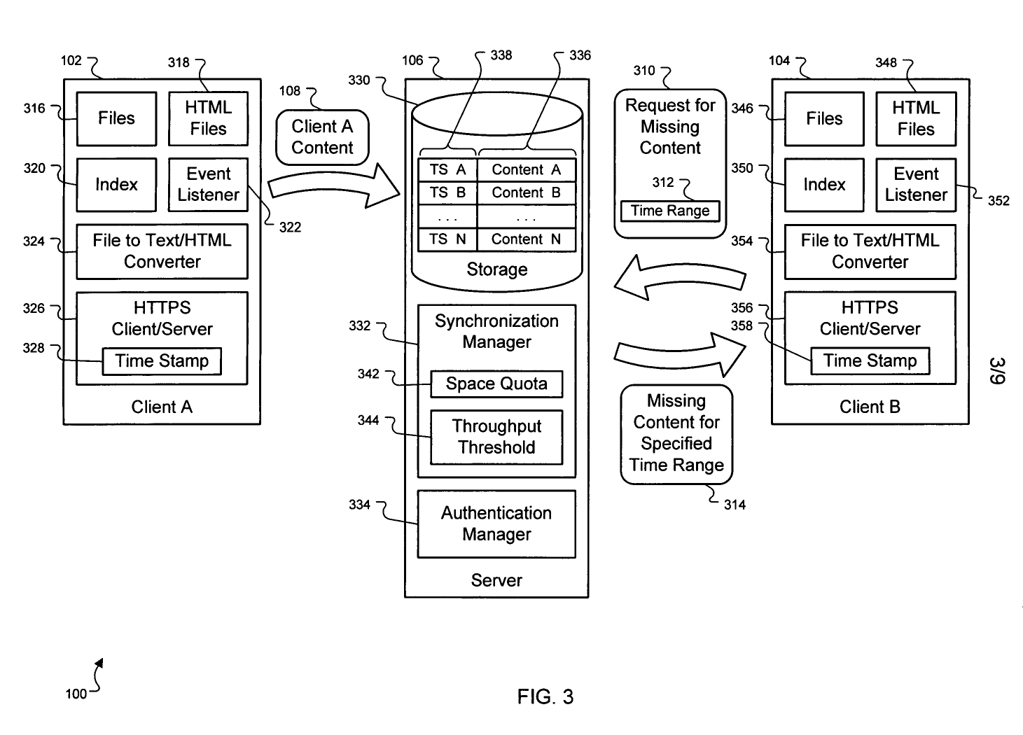

FIG. 3 is a block diagram showing the system 100 in FIG. 1 in more detail. The system 100 includes the Client A 102, the Client B 104, and the Server 106. The Client A 102 and the Client B 104 each represent a computer used by a user including, for example, a personal computer at home, a computers at work, and portable computers, such as a laptop computer, a PDA, and a cell phone. The Server 106 can act as a temporary storage location that facilitates synchronization between the user's clients. The Client A 102 posts the Client A Content 108 to the Server 106 after content is changed on the Client A 102. Posting of the Client A's Content 108 occurs, for example, whenever the user saves a file or document, or when he views a webpage. Posting can occur at set intervals, for example, every two minutes, and posting rates and strategies can be configurable. In some implementations, the posting occurs at a time relative to the event generated by the user's action. For example, the posting may occur at a predetermined time after a document is saved.

The Client A Content 108 is received by and stored in the Server 106. In order to keep its locally stored content synchronized with content from the other clients, the Client B 104 periodically issues a Request for Missing Content 310 to the Server 106. The Request 310 includes a Time Range 312 parameter identifying the range of time stamps for the missing content. The Request 310 is issued in order for the Client B 104 to obtain the Client A Content 108 that the Server 106 has yet to send to the Client B 104. To satisfy the request, the Server 106 locates its copy (if present) of the missing content using the Time Range 312 specified. The Server 106 can locate the content by checking time stamps stored in tables. The time stamps correspond to content received earlier by the Server 106 from the Client A 102. For example, the time stamps may indicate when the content was transmitted to the Server 106, or when the content was generated by a client. The Server 106 compares the time stamps to the Time Range 312 corresponding to the period of time that the Client B 104 has not received new content from the Server 106. If the Server 106 finds time stamps in its table within the specified Time range 312, then the Server B 106 sends a Missing Content for Specified Time Range 314 to the Client B 104. The Missing Content 314 includes the content with time stamps that fall within the Time Range 312.

The Client A 102 can include both data and applications. The data includes Files 316, hypertext markup language (HTML) Files 318, and an Index 320. The applications include an Event Listener 322, a File to Text/HTML Converter 324, and a hypertext transfer protocol secure (HTTPS) Client/server 326. The Files 316 can be, for example, text files, spreadsheets or documents produced by an application. The HTML Files 318 can be web pages viewed by the user on the user's various computers, thus providing a web browsing history. The Index 320 facilitates searching for content using an application, such as the Google™ Desktop, to search for key words in the content. The Event Listener 322 listens for and detects user actions, such as saving a file, deleting a file, or viewing a web page, that may require the associated content Client A Content 108 to be posted to the Server 106. The File to Text/HTML Converter 324 facilitates conversion of content into a format that may be viewed by clients with simple word processing applications or web browsers (e.g., it doesn't require reading the content with the application that generated the content). For example, the File to Text/HTML Converter 324 can be used to convert the Files 316 to an HTML format. The HTTPS Client/server 326 can be used as a client that tracks web access and can contain a Time Stamp 328 which associates viewed web pages with a time that they were accessed by the user. The HTTPS Client/server can also be used as a server to provide content to peer clients, which is described in more detail below.

The Server 106 can contain a Storage 330, a Synchronization Manager 332, and an Authentication Manager 334. The Storage 330 can contain the Content A, and Content B through Content N 336 that has been received from the user's various clients. Each of the items of content can have an associated time stamp TS A, and TS B through TS N 338, which can identify the time at which each of the items were created. The Synchronization Manager 332 contains a Space Quota 342 and a Throughput Threshold 344. The Synchronization Manager 332 can use the Time Stamps 338 to synchronize content stored on and shared between the Client A 102 and the Client B 104. It can also use the Time Stamps 338 and the Space Quota 342 to purge the oldest time stamped content, using for example, a first in, first out (FIFO) method whenever the storage space quota for the client is reached.

The Synchronization Manager 332 can use the Throughput Threshold 344 to restrict the number of bytes received or transmitted by a client over a specified time period. For example, Synchronization Manager 332 can transmit an error message to a client that receives or transmits content or requests for content that exceeds a specified maximum throughput rate (e.g., 2 Mb over 8 hours). The maximum throughput rate threshold can be configurable. The Authentication Manager 334 can provide security features that prevent unauthorized clients from using the Server 106 for storing and requesting content. Authentication can be based on, for example, a system for verifying user IDs and passwords. The Authentication Manager 334 can check the credentials of a client when the client connects to the Server 106. If a client supplies invalid credentials, the Authentication Manager can transmit an error message to the client.

Both Clients A and B 102, 104 can contain similar components and can accept and transmit content in a similar manner. For example, both clients can include Files 346, HTML Files 348, an Index 350, an Event Listener 352, a File to Text/HTML Converter 354 and an HTTPS Client/server 356. The HTTPS Client/server 356 contains a Time Stamp 358 that it can use to tag viewed web page content with the time that it was viewed. Additionally, the Time Stamp 358 may be attached to each of the generated content that is transmitted to the server, thus providing a transmission time associated with the content.

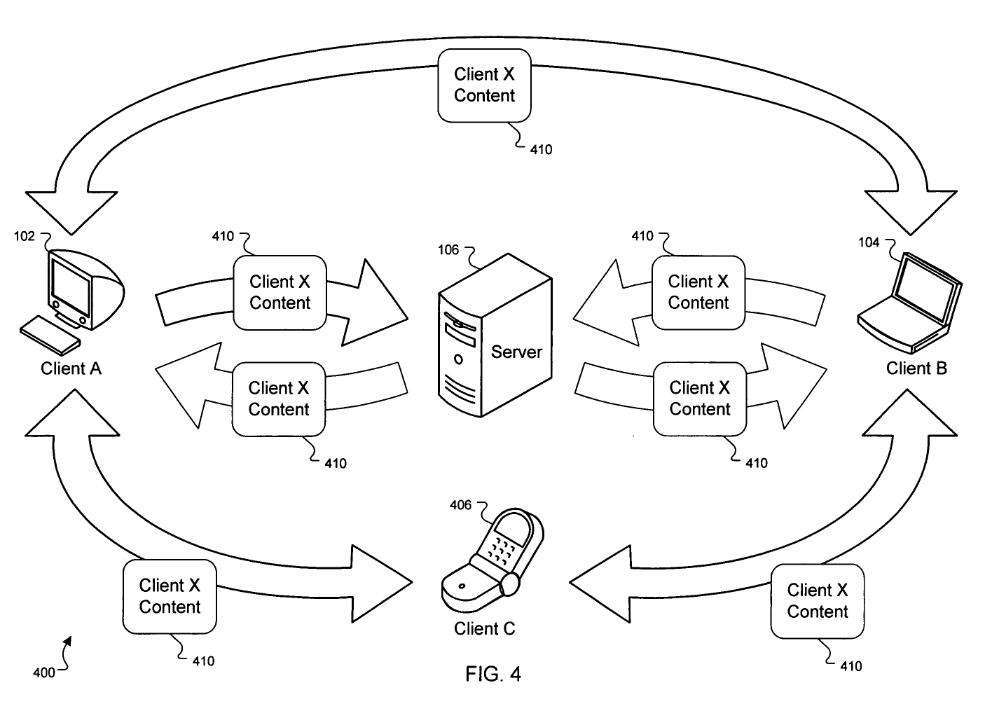

FIG. 4 is a schematic showing a system 400 for sharing and synchronizing content using a mixed peer-to-peer and client/server architecture. In the system 400, content still can be shared among the Client A 102, the Client B 104 and a Client C 406 using the Server 106 in a method similar to that of method 200 of FIG. 2. The peer-to-peer aspect of the system 400 is the addition of direct sharing of content among the Clients 102, 104 and 406, thus bypassing the Server 106. Direct content sharing among peer clients can make use of available resource capacities at the clients, thus reducing the bandwidth traffic at the Server 106. The Server 106 can still serve as a drop-box for temporarily (or permanently) storing Client X Content 410 originating from any the Clients 102, 104 or 406. The drop-box, or storage, capabilities of the Server 106 can be used, for example, if a particular client is offline when the first attempt is made to deliver new content to it. Although FIG. 4 does not show explicit arrows between the Client C 406 and the Server 106, the Client C 406 can have communicate with the Server 106 in a manner similar to the method used by the Clients A or B.

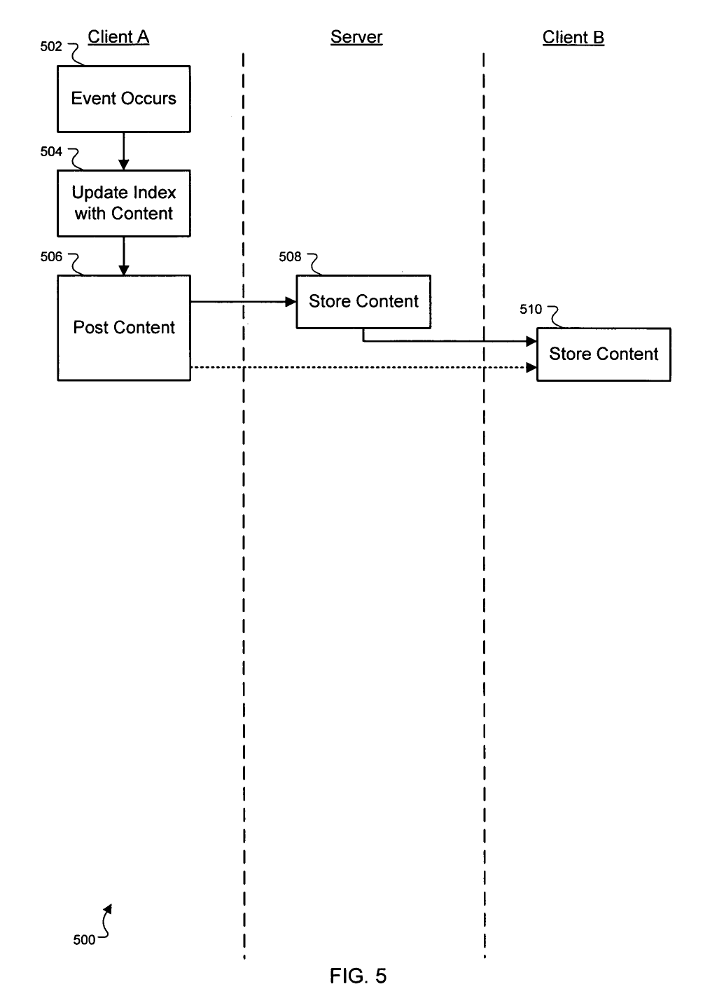

FIG. 5 is a sequence diagram showing an illustrative method for sharing and synchronizing content using the mixed peer-to-peer and server architecture of FIG. 4. Processing can start in step 502 when an event occurs. This step 502 may be similar to the step 202 of FIG. 2, where an event is generated in response to an action performed by a user, such as, saving a file or document, accessing a web page, or opening a file or application. For example, referring to FIG. 4, a user at the Client A 102 may edit and save a document on his work computer.

In step 504, the index is updated to reflect the event that occurred in step 502. For example, the index is updated to reflect the new saved version of the user's document. A search application, such as Google™ Desktop, can use the index to locate a copy of the file or the file's content on the client.

In step 506, the content originating on the client is posted to the server. The content can include a copy of the document (or the content of the document) that was saved by the user as well as metadata that describes information, such as the type of data, its source, when it was saved, and when it was posted to the server. For example, referring to FIG. 4, the HTTPS Client/server 326 of the Client A 102 can transmit an HTTP post command containing the Client X Content 410 to the Server 106.

In step 508, the server stores the content received from the originating client, and the content is propagated to the second client. For example, in FIG. 4, the Server 106 stores the Client X Content 410 on a storage device, then transmits the Client X Content 410 to the Client B 104.

In step 510, the content received from the server is stored on the second client's local storage device. For example, referring to FIG. 4, the Client B 104 stores the Client X Content 410 it received from the Server 106.

In an alternative embodiment, the step 506 can post the content to a peer client instead of the server, as shown by the dashed arrow pointing from the step 506 to the step 510. This embodiment can support a peer-to-peer aspect of the system 400 architecture by posting the content directly to a peer client. For example, referring to FIG. 4, the Client X Content 410 can be sent directly to the Client B 104 from the Client A 102, thus bypassing the Server 106. In a “daisy chain” of peer-to-peer clients, the content can originate on a first client and be sent directly to a second client, which in turn propagates the content to a third client, and so on. Also, in some implementations, the content can be transmitted from a first client to a second client, and then to a server, which can distribute the content to other clients. One possible advantage of using this “daisy chain” technique is to conserve a user's upstream bandwidth by delegating the uploading of data among several clients or the server, instead of requiring a single client to upload the content to all requesting clients or the server.

The system 400 can use several algorithms or rules to optimize the use of resources needed to synchronize the content among the various peer clients. Since bandwidth on the Server 106 and on the Clients 102 and 104 may be limited, and user actions can transmit or request large amounts of data at one time, content sharing can fall behind demand. For example, a user can store a very large document (e.g., a maintenance manual) on the Client A 102, and at a short time later, the same user empties a digital camera on the Client B 104. The same day, the user may go to work and update a small office memo on the Client C 406. Although the Server 106 can receive content for all three data items in the order that the user accessed them, the Server 106 can also deal with the data items by assigning it priorities. The Server 106 can handle the higher priority data items first, and save the lower priority data items for later. In one implementation, the priorities are based on attributes such as their size, type or age, which are each associated with a score. A lower combined score can be assigned a higher priority. For example, a small document (e.g., an office memo) would receive lower score based on size, thus a higher priority. Similarly, a large document (e.g., a maintenance manual) and digital photos would receive a higher score (and a lower priority). A data item's age would also affect its priority, with a higher priority being assigned to a newer data item. A data item's type can also be used to calculate its priority, since, for example, an office environment can place a higher priority on work-related data items, such as documents generated by Microsoft Word™. In some implementations, the priority algorithm is used by each of the clients to determine when to transmit content from that client to the server or another client.

The priority formula of one implementation can be stated as 1000* log_{N}(s) sqrt (t/K)/B_{type}, which is explained as follows: a data item would be assigned a base priority of 1000. The base priority is multiplied by the square root of the scaled time at which it was generated. This serves to significantly raise the priority of a very new data item. The priority is multiplied by log_{N}(s) (the logarithm with the base N of s), where N is a constant and s is the size of the file in kilobytes. That way, small files would get priority over large files, yet large files do not get pushed too far to the back of the priority list since the factor is not linear. Finally, a constant “boost factor” B can be applied based on the type of the data item. The boost factor is 1 by default, but can be different for different types of data items (e.g., B_{ms-office}=2}), where ms-office signifies a Microsoft Office™ document.

The system 400 can use this priority formula to determine how content is shared among clients. For example, depending on available bandwidth on the Clients 102, 104, 406, and on the Server 106, and the priorities associated with the data items being shared, the system 400 can spread the sharing load over a combination of clients. For example, referring to FIG. 4, the Client A 102 can send Client X Content 410 directly to both the Client B 104 and the Client C 406. Alternatively, the Client A 102 can send the content just to the Client B 104 and request the Client B 104 to replicate it to the Client C 406. Either way, the Server 106 can be bypassed in this peer-to-peer content sharing process, particularly if it does not have available bandwidth.

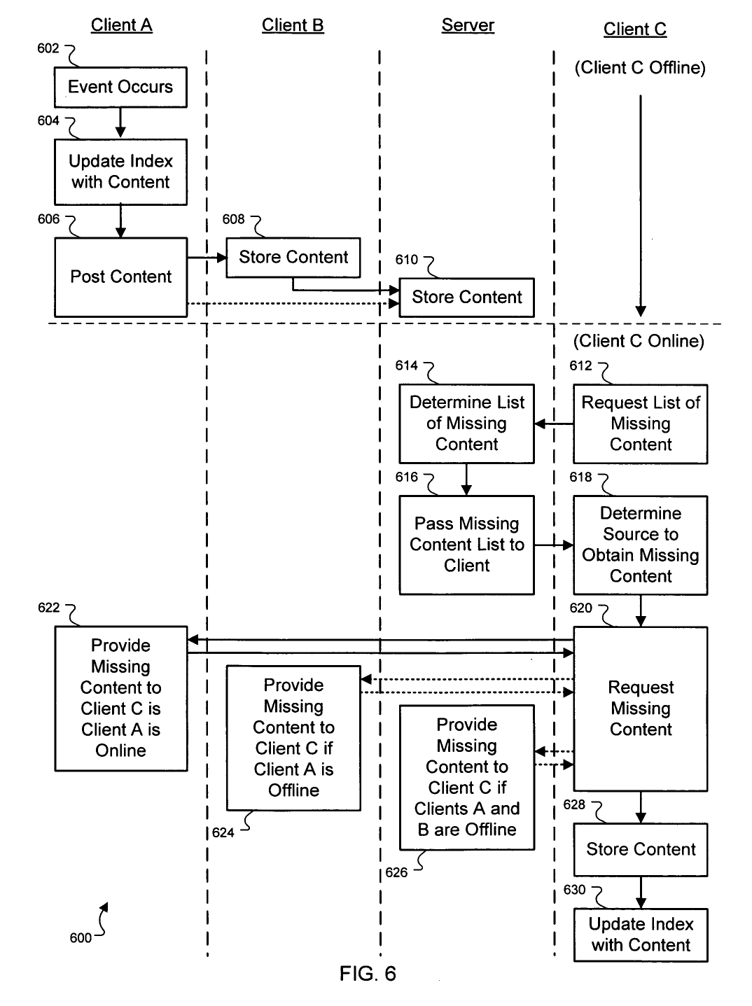

FIG. 6 is another sequence diagram showing an illustrative method for sharing and synchronizing content using a mixed peer-to-peer and server architecture of FIG. 4 when a client that is offline comes online. In this case, the system 400 automatically detects that a particular client is offline. In one implementation, determination of whether a client is online or offline can be made by monitoring polling by the client. If no request is received from a client, then the client is assumed to be offline. Similarly, the Server 106 can maintain a table of client IDs and whether each client is online or offline. When a client comes online, it can notify the Server 106 that it is online, and the Server 106 can update its table of clients with the online status.

The system 400 can enable peer-to-peer content sharing and synchronization using a combination of peer-to-peer and “drop box” techniques. The peer-to-peer techniques can be used by clients that are currently online to share the content directly between the clients. However, in order for the system 400 to supply the content to an offline client, the server can be used as a drop box for the content until the offline client comes online again.

Processing can start in step 602 when an event occurs. This step 602 may be similar to the step 202 of FIG. 2, where an event is generated in response to an action performed by a user, such as, saving a file or document, accessing a web page, or opening a file or application. For example, referring to FIG. 4, a user at the Client A 102 may edit and save a document on his work computer.

In step 604, the index is updated to reflect the event that occurred in step 602. For example, referring to FIG. 4, the index is updated to reflect the new saved version of the user's document. The index makes the file easily locatable on the client.

In step 606, the content originating on the first client is posted to a second client, thus initiating a peer-to-peer content flow. The content can include a copy of the document that the user saves as well as metadata that describes the type of data, the client that generated the data, and when the data was last changed. For example, referring to FIG. 4, the Client A 102 sends the Client X Content 410 to the Client B 104, where the Content 410 is transmitted with metadata that includes the source of the content (Client A 102) and when it was generated.

In step 608, the second client stores the content received from the originating client, enabling a user at the second client to view the document created at the first client. In this step, the second client also propagates the content to the server. In some implementations, the second client would propagate the data directly to a third client if the third client (e.g., the Client C) was online, but in this case, the third client is offline, so the content is transmitted to the server for temporary storage. For example, in FIG. 4, the Client B 104 stores the Client X Content 410 on its local storage device, then transmits the Client X Content 410 to the Server 106. If the Client C was online, the Client B 104 could propagate the content directly to the Client C 406; however, the Client C 406 is offline, so the Client B 104 propagates the data to the Server 106 instead.

In step 610, the content received from the second client is stored on the server's storage device. For example, referring to FIG. 4, the Server 106 stores the Client X Content 410 it received from the Client B 104 in the Storage Device 330.

An alternative embodiment of step 606 bypasses the second client and sends the data directly to the server, as shown by the dashed line pointing from the step 606 to the step 610. For example, referring to FIG. 4, the Client X Content 410 can be sent directly to the Server 106, thus bypassing the Client B 104. The Server 106 can then transmit the content to the remaining client peers, such as the Clients B and C.

Step 612 can occur after the third client comes online, having been offline during the time that the content originated on the first client and was propagated to the second client and to the server. In step 612, the third client requests a list of missing content from the server. For example, the Client C 406 requests a list of missing content from the Server 106 when it connects to network that links the server and other clients, such as the Internet.

In step 614, the server determines the content missing from the third client. The determination can be made based on time stamped content stored at the server and the time range representing the time period during which the third client was offline and not receiving content. For example, referring to FIG. 4, the Server 106 determines the content missing from the Client 406 by determining what content was uploaded to the Server since the Client 406 last contacted the Sever. The Server can make this determination by comparing the TSs 338 with the time that the client C is currently requesting a list of the missing content. Any content with TSs between when the Client C last logged on and its current log on is assumed to be missing from the Client C.

Alternatively, the time range specified by a client could be arbitrary. For example, the Client C may specify a beginning and an ending point of the time range that is based on content that it does not yet have stored, regardless of when the Client C has last logged on. This may be used in combination with the priority formula discussed above. For instance, a client may log on to the server, but not download content for a certain time period because it has been given a lower priority. Later, the client may specify this time range for downloading the content even if the client has downloaded content that associated with time ranges that occurred after the time range of the lower priority content.

In some implementations, the Server 106 may not contain the actual content, but may contain a list of the content that was generated during the time that the Client C was offline. For example, the Client A may access a very large file during the time that the Client C is offline. The content of this file may not be transmitted to the Server 106 because of the execution of a priority algorithm (as discussed earlier). Instead, metadata describing the file and the time it was accessed may be transmitted to the Server. This metadata may be included in a list tracking content that was generated during the time that the Client C was offline even though the content is not currently stored on the Server 106.

In step 616, the server passes the list of missing content to the third client (e.g., Client C), which had been offline. The list identifying the missing content includes metadata describing the type of data that is missing, time ranges associated with the accessing or transmission of the data, and the client source or sources of the missing content. For example, referring to FIG. 4, the Server 106 sends the Client C 406 a list of missing content that it can obtain from the server or directly from the source clients.

In step 618, the third client uses the list it received from the server to determine where it can obtain the missing content. The missing content may exist on other peer clients, the content may be stored at the server, or the content may be stored at both the client and the server. For example, referring to FIG. 4, the Client C 406 may determine that it can synchronize its content by requesting the Client X Content 410 (which is the Client A's content in this case) from the Client A 102. In the current example for FIG. 6, the content happened to originate on the Client A 102, but a client can request content from any client that has a copy of the missing content, regardless of where the content originated.

In step 620, the third client requests the missing content from the first client, provided the first client is online at the time. For example, referring to FIG. 4, the Client C 406 requests the Client X Content 410 from the Client A 102 if the Client A is currently networked to the Client C. The content requested is based on the time range corresponding to the time stamps of content resident on the Client A 102 but not resident on the Client C 406.

In step 622, the first client provides the missing content to the third client. For example, referring to FIG. 4, the Client A 102 sends the Client X Content 410 to the Client C 406.

In an alternative embodiment of step 620, the first client can be offline at the time of the third client's request for missing content. In this implementation, the third client can obtain the missing content from another client that is online. For example, the Client C 406 requests the Client A's content 410 from the Client B 102. Of course, the Client A would have had to previously transfer the requested content to the Client B at a time when both the Client A and the Client B were online, as indicated in the step 608.

In step 624, the second client sends the missing content to the third client. For example, referring to FIG. 4, the Client B 104 sends the Client A Content 410 to the Client C 406.

In another alternate embodiment of step 620, both the first and second clients can be offline at the time of the third client's request for missing content. In this case, the third client can obtain the missing content from the server. For example, the Client C 406 requests the Client X Content 410 from the Server 106. Additionally, the Client C 406 can request the content from the Server even if the one or more other clients are online. For instance, the Client C may request the content from the Server if the other clients have less available bandwidth relative to the Server.

In step 626, the server sends the missing content to the third client. For example, referring to FIG. 4, the Server 106 sends the Client X Content 410 to the Client C 406.

In step 628, the content received by the third client is stored on the client's local storage device. For example, referring to FIG. 4, the Client X Content 410 received by the Client C 406 is stored on the client's local storage device.

In step 630, the index of the client is updated to incorporate searchable information corresponding to the content received by the third client. For example, referring to FIG. 4, the index stored at the Client C 406 is updated with searchable information corresponding to the Client X Content 410 it received. After the content is associated with the index, a search application, such as Google™ Desktop, may locate the content when a user enters key words present in the content into a user interface for the search application.

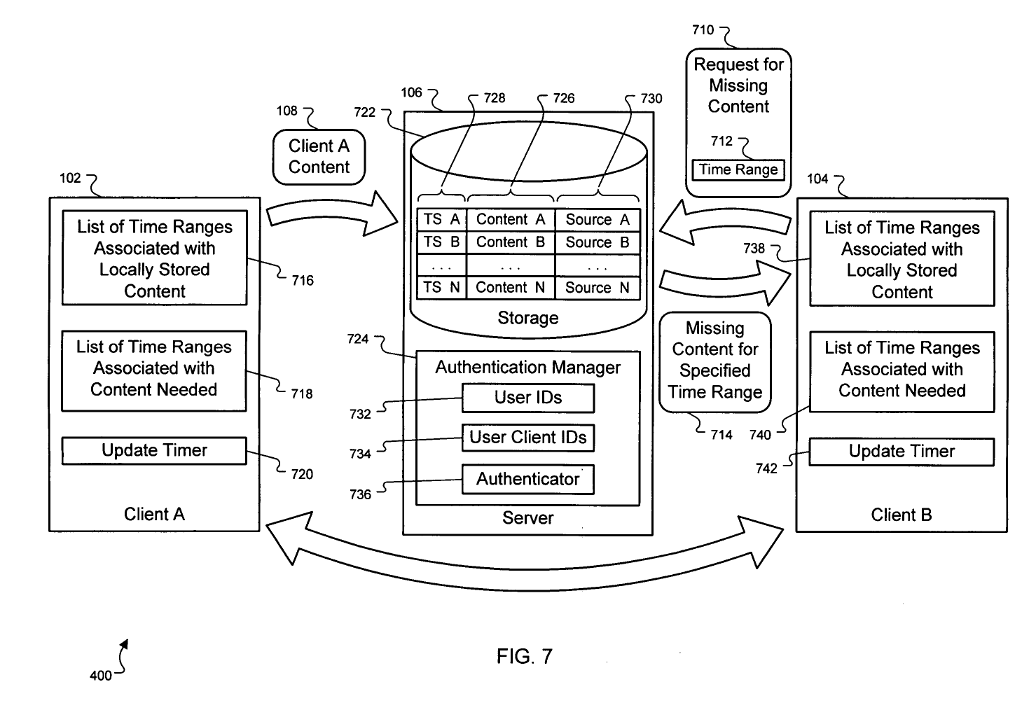

FIG. 7 is a block diagram showing particular components of the system shown in FIG. 4 in more detail. As discussed above, the system 400 includes the Client A 102, the Client B 104, and the Server 106, where the Client A 102 and the Client B 104 represent a user's various computers. The Server 106 serves as a temporary storage location that can facilitate synchronization between the user's clients.

The Client A 102 posts Client A Content 108 to the Server 106 when content is changed on the Client A 102. Posting of the Client A Content 108 occurs, for example, whenever the user saves a file or document, or when he views a webpage. Posting can occur at set intervals, for example, every two minutes, and posting rates and strategies can be configurable. Alternatively, posting can occur as soon as an event is generated by an action, such as saving a file. For example, a client can maintain an open connection with a server and post as soon as an event is generated. In this connection-oriented architecture (regardless of whether the connection is peer-to-peer or client-to-server), each of the clients can push new data to the other clients instead of waiting until the other clients send a request for missing information.

The Client A Content 108 is received by and stored in the Server 106. In order to keep its locally stored content synchronized with content from the other clients, the Client B 104 periodically issues a Request for Missing Content 710 to the Server 106. The Request 710 includes a Time Range 712 parameter identifying the range of time stamps for the missing content. The Request 710 is issued in order for the Client B 104 to obtain the Client A Content 108 that the Server 106 has yet to send to the Client B 104. To satisfy the request, the Server 106 locates its copy of the missing content using the Time Range 712 specified, and it sends the Missing Content for Specified Time Range 714 to the Client B 104.

Similarly, using a peer-to-peer architecture, the Client B 104 can request missing content from another client. For example, the Client B 104 can issue a Request for Missing Content 710 to the Client A 102. The Client A 102 can locate the data on its storage device and send it to the Client B 104 in a Missing Content for Specified Time Range 714.

The Client A 102 includes a List of Time Ranges Associated with Locally Stored Content 716, a List of Time Ranges Associated with Content Needed 718, and an Update Timer 720. The Lists of Time Ranges 716 and 718 facilitate synchronization of the content on the Client A 102 with the content stored on other clients and the server. For example, the List of Time Ranges Associated with Locally Stored Content 716 corresponds to content created locally on the Client A 102 plus any content created on other clients, such as the Client B 106, but stored on Client A. Similarly, the List of Time Ranges Associated with Content Needed 718 corresponds to content that the Client A 102 needs to acquire. In a peer-to-peer and Client/Server mixed architecture, the missing content can be acquired from the Server 106 or from another peer client, such as Client B 104. As content is received at the Client A 102, the corresponding time ranges are moved from the Needed List 718 to the Locally Stored List 716. The Update Timer 720 is used to keep track of when the client needs to connect to the server or to other clients to obtain new lists of missing info, provide lists of newly created content (or the content itself), and connecting to download content it has not yet received.

The Server 106 contains Storage 722 and an Authentication Manager 724. The Storage 722 contains the Content A, Content B, and so on through Content N 726 that have been received from the various clients in the peer-to-peer architecture. Each of the items of content has an associated time stamp TS A, TS B, and so on through TS N 728, which identify the time at which each of the Contents 726 was last updated. Additionally, each of the Contents 726 has an associated Source A, Source B, and so on through Source 730, which identifies the content's source, or client ID. The Authentication Manager 724 authenticates users and clients that attempt to access the server to store or request content. The Authentication Manager 724 can include a list of User IDs 732 that are associated with clients permitted to access the Server 106, a list of User Client IDs 734 that identify the clients associated with a user, and an Authenticator 736 which uses the User IDs 732 and User Client IDs 734 to prevent unauthorized use of the Server 106 and the content it has in Storage 722.

In some implementations, the Authentication Manager 724 does not include all of the elements shown in FIG. 7. For example, the Manager 724 may not include the list of User Client IDs 734 because these IDs are not used in authentication in these implementations. Instead, the User Client IDs 734 can be used primarily for indicating which of the user's machines transmitted the received content.

The Client B 104 can perform similar functions as the Client A 102 and can contain similar components including: a List of Time Ranges Associated with Locally Stored Content 738, a List of Time Ranges Associated with Content Needed 740, and an Update Timer 742.

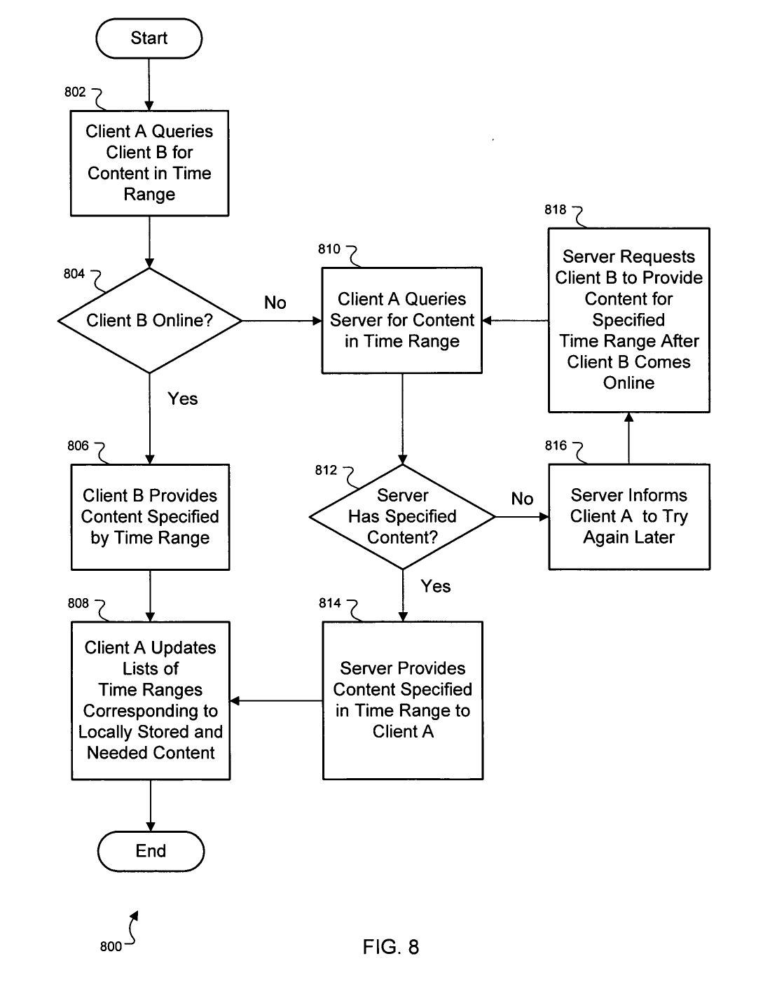

FIG. 8 is a flow chart showing an illustrative method 800 for sharing and synchronizing content across multiple client devices according to the implementation shown in FIG. 4. For example, the method can be performed by the system 400. The method 800 can begin in step 802 when one client queries a second client for content in a specified time range. For example, referring to FIG. 7, Client A 102 may query Client B 104 for content in a time range representing the time since the last synchronization. The time range information can be a subset of the List of Time Ranges Associated with Content Needed 718 in the Client A 102.

In step 804, it is determined if the second client is online. For example, referring to FIG. 7, the system determines if Client B 104 is online. If so, it may be possible to obtain the needed content directly from Client B 104.

If the answer in step 804 is yes, the second client provides the requested content in step 806. The content provided corresponds to the time range specified in step 802. For example, referring to FIG. 7, the Client B 104 sends the requested content to the Client A 102, which stores the content locally.

In step 808, the client receiving the content updates its time range list corresponding to the content it already has and also updates the list that identifies the content the client still needs. The time range lists are specific to each client that serves as a source for content. When content is received from a client, the time range is removed from the list of content needed from the source, and the time range is added to the list of locally stored content from that source. For example, referring to FIG. 7, the List of Time Ranges Associated with Content Needed 718 is decreased by the time range, and the List of Time Ranges Associated with Locally Stored Content 716 is increased by the time range. Upon completion of step 808, the query for content and the delivery of the content are complete.

Step 810 is executed if the determination of step 804 is that the Client B is not online or cannot provide the content requested by the first client's query. In this case, the first client queries the server to obtain the needed content. For example, referring to FIG. 7, the Client B 104 queries the Server 106 for the needed content.

In step 812, it is determined if the server has the specified content. The content may no longer exist on the server if it was deleted, for example, due to retention rules, storage quotas, or an unforeseen loss of data. For example, referring to FIG. 7, the Server 106 attempts to locate the needed content in Storage 722. The search occurs using the time range corresponding to the content that is needed. For example, the Server 106 compares time range of the request to the time stamps TS 728 of the content within Storage 722. If the time stamps are within the specified time range, then the Server 106 can meet the request of the Client A 102. If the content is not within the Storage 722, the Server 106 may request it from the client that originated the content. After the Server receives the requested content, it may transmit it to the Client A 102.

Retention rules within an organization can state that documents can be retained for a limited time (e.g., two years) before they must be destroyed. At the end of the specified retention period, the document can be deleted, possibly automatically, on the client. Each client or server of the system 800 can transmit a command to the other clients or servers to delete the corresponding content. Additionally, the metadata associated with the content can include expiration dates or other retention rules. This metadata may be transferred along with the content to all of the requesting clients. In this way, the clients that received the content and metadata can delete the content associated with the rules or expiration dates, even if the receiving client does not connect to the network after receiving the content (and therefore never receives the command to delete the content).

Storage quotas on a server can limit the amount of data stored by a user. For example, the Server 106 may have a configurable storage quota for each client it serves. The Client A 102 (e.g., a user's work computer) may transmit content to the Server 106 until the client exceeds its storage quota. In some implementations, the Server 106 may have a FIFO system for handling a client's transmitted content relative to its quota. If the client's quota is exceeded, the new content can be accepted, but the oldest content can be deleted. If the content is deleted before another client (e.g., a user's home computer that has been offline for months) is able to receive it, then the client can be forced to obtain the content elsewhere. In this example, the client (e.g., user's home computer) can obtain the content directly from his work computer. Alternatively, the Server may request the content from the client that generated the content and transmit the content to the requesting client.

The Server 106 may have deleted the content because of an optimistic deletion policy. The Server 106 can include a list of all active clients associated with a particular user ID. An active client can be defined as a client that has contacted the server within a predetermined time period, such as three months. After the Server determines that received content has been transmitted to the active clients included in the list, the Server may delete that received content. If an inactive client (a client that has not contacted the Server within the predetermined time) transmits a request for the deleted content, the Server may request that the client that originally transmitted the content retransmit it. The Server may then provide it to the previously inactive client.

If the answer in step 812 is yes, the server provides the needed content in step 814. The content provided corresponds to the time range specified in step 810. For example, referring to FIG. 7, the Server 106 sends the needed content to the Client A 102, which stores the content locally and updates its list of time ranges corresponding to content it needs and content stored locally.

If the answer in step 812 is no, the server can signal the first client to request the content at a later time.

In step 818, the server requests the second client to provide the missing content it needs to satisfy the original query received from the first client. In one implementation, the server can wait until it detects that the second client is online, then issue the request. In another implementation, the server may wait to issue the request until sometime after the second server comes online, permitting the second client to first complete higher priority tasks. For example, referring to FIG. 7, the Server 106 waits for the Client B 104 to come online, and ultimately requests the missing content from the Client B.

Regardless, the server can locate a copy of the requested content. For example, referring to FIG. 7, the system determines if Client B 104 is online. If so, it is possible to obtain the needed content directly from Client B 104.

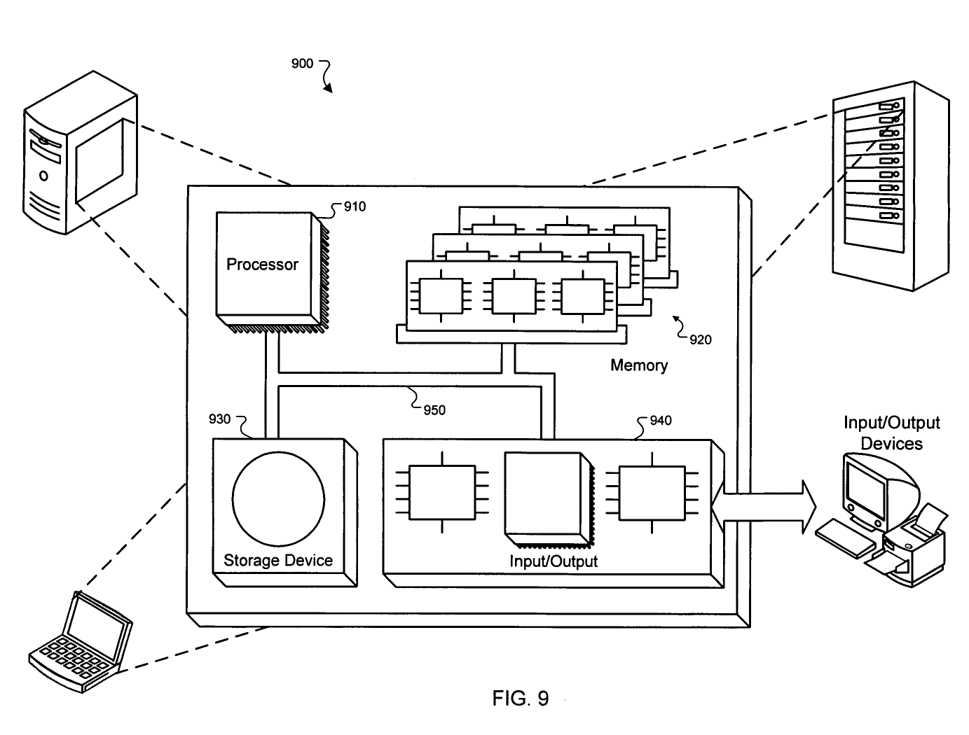

FIG. 9 is a schematic showing a general computer system. The System 900 can be used to execute the steps performed in the method 800 and the sequences 500 and 600, according to one implementation. For example, the System 900 may be included in either or all of the Client A 102, the Client B 104, and the Server 106.

The System 900 includes a Processor 910, a Memory 920, a Storage Device 930, and Input/Output Devices 940. Each of the components 910, 920, 930, and 940 are interconnected using a System Bus 950. The Processor 910 is capable of processing instructions for execution within the System 900. In one implementation, the Processor 910 is a single-threaded processor. In another implementation, the Processor 910 is a multi-threaded processor. The Processor 910 is capable of processing instructions stored in the Memory 920 or on the Storage Device 930 to display graphical information for a user interface on the Input/Output Devices 940.

The Memory 920 stores information within the System 900. In one implementation, the Memory 920 is a computer-readable medium. In another implementation, the Memory 920 is a volatile memory unit. In another implementation, the Memory 920 is a non-volatile memory unit.

The Storage Device 930 is capable of providing mass storage for the System 900. In one implementation, the Storage Device 930 is a computer-readable medium. In various different implementations, the Storage Device 930 may be a floppy disk device, a hard disk device, an optical disk device, or a tape device.

The Input/Output Devices 940 provides input/output operations for the System 900. In one implementation, the Input/Output Devices 940 includes a keyboard and/or pointing device. In another implementation, the Input/Output Devices 940 include a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments have been described. Nevertheless, it will be understood that various modifications may be made without departing from the spirit and scope of the described embodiments. For example, the system 400 shown in FIG. 4 can be modified to use a peer-to-peer architecture without the Server 106. If a client, such as the Client A 102, attempts to transmit content to another client that is offline, such as the Client B 104, the Client A 102 can hold the content and continue to make transfer attempts until the Client B 104 comes back online instead of transferring the content to the Server 106 for temporary storage. Alternatively, the Client A 102 can transfer the content to a client other than the target Client B 104 if the target client is offline. For example, the Client A 102 can transfer the content to the Client C, which transfers the content to the Client B 104 when it comes online.

Also, in another implementation, the clients may specify the content with bit ranges instead of time ranges. For example, a client may request from the Server 106 content, which is specified by a first bit value (that indicates the starting bit of content data) to a second bit value (that indicates the ending bit of content data). Likewise, the Time Range lists 716, 718, 738 and 740 can contain bit ranges associated with locally stored content and bit ranges associated with content needed, respectively. Accordingly, other embodiments are within the scope of the following claims.

What is claimed is:

1. A method comprising:
receiving an event indicating an action associated with a first file has been performed by a user using a first client, wherein the action is unrelated to transmitting the first file to another client;
automatically extracting content from the first file in response to the event using the first client and generating metadata to associate with the content; and
transmitting, using the first client, the content and the metadata to a peer client if the peer client and the first client are currently operating and visible to each other on a network, wherein the timing of the transmission is determined automatically after the event is received.

2. The method of claim 1, wherein the action that is unrelated to transmitting a file is a file access or a file save, and the extracted content from the first file is a copy of the file or a copy of the contents of the file.

3. The method of claim 1, further comprising receiving from a server an indication that the server is configured to transmit the content to a requesting client; and having received the indication and if the peer client is not currently networked to the first client, transmitting the content and the metadata to the server.

4. The method of claim 3, further comprising receiving requirements from a server, locating the metadata that meets the requirements, and selecting the content associated with the metadata for transmission to the peer client.

5. The method of claim 4, wherein the requirements include time stamp values or data bit values.

6. The method of claim 5, further comprising extracting additional content from a plurality of files using the first client in response to a plurality of events occurring on the first client and transmitting the additional content to the peer client based on one or more priority algorithms that specify an order in which the additional content is to be transmitted.

7. The method of claim 1, wherein transmitting the content and metadata to a peer client includes transmitting the content and the metadata to a server, the first client receiving an indication from the server that the server is configured to transmit the content and the metadata to the peer client.

8. The method of claim 1, wherein transmitting the content and metadata to a peer client includes transmitting the content and the metadata to a second client, the first client receiving an indication from the second client that the second client is configured to transmit the content and the metadata to the peer client.

9. The method of claim 1, further comprising indexing the content before it is transmitted to the peer client so that one or more symbols included in the content are formatted as keys operable to identify the content.

10. The method of claim 1, further comprising extracting content from a second file independent of an event occurrence, indexing the content from the second file, and transmitting the indexed content to the peer client.

11. The method of claim 1, wherein extracting the content from the first file includes converting the content of the first file into hypertext markup language (HTML) or text.

12. The method of claim 1, wherein extracting the content of the first file includes generating a copy of the first file that retains the first file's original file formatting.

13. The method of claim 1, further comprising increasing a throughput threshold for limiting an amount of content passed between the first client and the peer client if an indication is received at the first client that a network connection between the first client and the peer client has a bandwidth that exceeds a predetermined bandwidth value.

14. The method of claim 1, further comprising associating an expiration date with the content before it is transmitted to the peer client.

15. The method of claim 1, further comprising transmitting a request to delete the content from the peer client if the content is deleted from the first client.

16. A computer system having one or more servers comprising:
a table manager module to receive an indication from a first client that a user has performed an action on a file that is unrelated to a transfer of the file, the indication including content extracted from the file and a metadata value assigned to the content;
a data table to store the content extracted from the file on the first client and the metadata value;
an interface to receive from a second client a request for content that is associated with one or more metadata values within a specified metadata value range; and
a selection module to initiate transmission of the content to the second client if the metadata value associated with the content is within the specified metadata value range.

17. The system of claim 16, wherein the metadata value includes a time stamp that indicates when the action performed on the file occurred, and the metadata value range includes a sequential range of time stamp values that indicate a period of time.

18. The system of claim 16, further comprising an active client list that includes identifiers for clients from which requests for content have been received by the interface within a predetermined period of time, the active client list being used by the table manager module to determine if the content has been transmitted to all listed active clients before the table manager module issues a delete command to remove the content from the data table.

19. The system of claim 16, further comprising a space quota that includes a limit on an amount of storage space for received content, the space quota being used to trigger a deletion of at least a portion of the content from the data table when the quota is exceeded.

20. The system of claim 16, further comprising a list of source identifiers, one of which specifies the first client from which the content was received, the list of source identifiers being used to initiate a request for the content from the first client if the content has been deleted from the data table before the content is transmitted to the second client.

21. The system of claim 16, further comprising an authentication manager to transmit client identifiers for the first and second clients and a user identifier associated with the first and second clients to an external server for use in reconstructing the content if the content stored in the data table becomes inaccessible.

22. The system of claim 16, further comprising a throughput threshold that includes a limit on an amount of data that is received by the interface within a predetermined time period, the throughput threshold being used by the interface to refuse the receipt of additional content if the amount of data received exceeds the threshold.

23. A system for sharing data across multiple clients comprising:
an event listener at a first client to receive a user-initiated action associated with a file, wherein the action is unrelated to transmitting the file to a second client;
an extractor at the first client to extract content from the file in response to the event and to generate metadata that is associated with the context; and
means for transmitting the content and the metadata from a first client to a second client.

24. A computer program product tangibly embodied in a tangible, machine-readable information carrier, the computer program product including instructions that, when executed, perform a method comprising:
receiving an event indicating an action associated with a first file has been performed by a user using a first client, wherein the action is unrelated to transmitting the first file to another client;
automatically extracting content from the first file in response to the event using the first client and generating metadata to associate with the content; and
transmitting, using the first client, the content and the metadata to a peer client if the peer client and the first client are currently operating and visible to each other on a network, wherein the timing of the transmission is determined automatically after the event is received.
